(19) United States
(12) Patent Application Publication
(10) Pub. No.: US 2010/0301262 A1
(43) Pub. Date: Dec. 2, 2010

(54) Composition and process for controlling particle size of metal oxides

(76) Inventor: Yun-Feng Chang, Houston, TX (US)

Correspondence Address: DR. YUN-FENG CHANG, 4443 STERLING WOOD WAY, HOUSTON, TX, 77059, US

(21) Appl. No.: 12/454,825

(22) Filed: May 26, 2009

(51) Int. Cl. C09K 13/00

(52) U.S. Cl. 252/79.1

(57) ABSTRACT

Composition and processes to prepare a polishing medium to be used in chemical and mechanical polishing applications.

### FIELD OF THE INVENTION

The present invention relates to a composition and a process for forming a mixture of metal oxides, and more particularly a process for forming metal oxide particles having a desirable particle size distribution.

### BACKGROUND OF THE INVENTION

For semiconductor industry, the first step of computer chip making is to prepare a silicon wafer with a highly uniform and smooth surface to achieve surface planarization. Continued miniaturization of the silicon integrated circuit (Si IC) device dimensions and related need to interconnect an increasing number of devices on a chip have led to building multilevel interconnections on planarized levels. Typically, this requires a precise removal of usually less than 0.5 microns materials from the surface of the silicon wafer to achieve efficient surface planarization. Maintaining the precise control on remaining thickness, which is also very small (≦0.5 microns), to within 0.01-0.05 microns while maintaining the integrity of underlying structures are added requirements. This stringent criteria for chemical and mechanical polishing (CMP) has challenged both scientists and engineers in the field.

There are many factors that may affect the surface planarization, including pads, abrasives, slurry chemistry, post-CMP cleaning, and feature size dependency. One of the key factors of the CMP process is the polishing medium. CMP process calls for application of a polishing medium in the form of slurry when the surface of the unpolished silicon wafer or other surfaces of an article is in contact with a fast moving polishing pad. The pad provides the mechanical movement and supports and holds the polishing medium while the polishing medium does the removal of the surface by mechanical and chemical abrasion or erosion. Therefore, there is a strong desire for a polishing medium that enables fast polishing and surface perfection to improve the CMP process.

### DETAILED DESCRIPTION OF THE INVENTION

The present invention provides a method of production and a composition of polishing medium by using a combination of surface modification and milling.

According to one aspect of the invention, a process is provided to produce polishing medium of desired particle size and size distribution. For CMP application, apart from abrasiveness or harness of particles, particle size and particle size distribution of polishing medium particles are key factors determining both the polishing efficiency and quality of polishing. Particles of the polishing medium can be produced by direct synthesis routes or by post-synthesis treatment methods. One particular useful method to achieve desired particle and particle size reduction is by using a particle size reduction technique. Commonly known particle size reduction methods include but limited to high shear milling, and medium milling.

In one embodiment of the invention, a milling process is provided to produce polishing medium of desired particle size and size distribution. “Milling” refers to a process to reduce particle size by vigorous mechanical agitation, collision among targeted particles, high shear stress at the surface of the targeted particles leading to fracture, breakdown, and weakening of the integrity of the targeted particles. One particular type of mill is called medium mill as it requires a milling medium to create turbulence in addition to the high agitation speed, vertices, high surface stress or shear. Known medium mills include Eiger mills from Eiger Machinery Inc, Grayslake, Ill., Netzsch mills from Netzsch Fine Particle Technology, Exton, Pa., Puhler mills from Puhler Machinery and Equipment Col, Guangzhou, Guangdong, China, etc.

Particle size distribution (PSD) describes the relative proportion of individual particle size. Polishing medium consists of particles ranging from nanometers to a few microns. Particles smaller than one micron are also often called colloidal particles. Brownian motion is a characteristic property of colloidal particles. Typically particles in the size range of 1 nm to 100 nm are regarded as colloidal particles. There are other classifications or definition on colloidal particles, for example, being in the range from 5 nm to 500 nm (see J-E. Otterstedt and D. A. Brandreth, Small Particles Technology, Plenum Press, N.Y., 1998, p. 8). Particles above 500 nm or 0.5 micron in size often settle from water in a matter of days, but if they are less than 70 nm, they do not settle easily under gravity because of Brownian motion keeps them in suspension.

Particle size or particle size distribution (PSD) measurements are obtained by commonly known techniques like (1) sedigraph, for example, Micromeritics SediGraph 5000E, SediGraph 5100 based on particle sedimentation measured by x-ray. It measures particles in the range of 0.5 micron to 250 microns; (2) laser scattering, which measure light scattering by particles, particularly small particles, for example, Horiba LA910, Microtrac S3500, measuring particles in the range of 10 nm to 3000 microns; (3) acoustic and electro-acoustic techniques, for example, Matec ESA 9800, and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; (5) electroresistance counting method. An example of this is the Coulter counter, which measures the momentary changes in the conductivity of a liquid passing through an orifice that take place when individual non-conducting particles pass through. The particle count is obtained by counting pulses and the size is dependent on the size of each pulse; (6) high sensitivity electrophoretic laser scattering technique, like Brookhaven Instruments ZetaPals and ZetaPlus, measuring particles of 10 nm to 10 microns; (7) electron microscopic imaging, scanning electron microscopy (SEM) and transmission electron microscopy (TEM); (8) optical microscopy.

For samples that contain particles ranging from a few nanometers to a few millimeters more than one technique are often required to get the full particle size measurements. More comprehensive discussion of particle size measurements using light scattering method can be found in the book, “Particle Characterization: Light Scattering Method”, by Renliang Xu, Kluwer Academic Publisher, Dordrecht, The Netherlands, 2000. More generic treaty of fine particle characterization can reference monograph “Analytical Methods in Fine Particle Technology”, by P. A. Webb and C. Orr, Micromeritics Instrument Corp., Norcross, Ga. More comprehensive discussion about particle characterization and preparation can reference the book by J-E. Otterstedt and D. A. Brandreth, “Small Particles Technology”, Plenum Press, N.Y., 1998; and book by A. M. Spasic and J-P. Hsu, “Finely Dispersed Particles: Micro-, Nano-, and Atto-Engineering”, Taylor & Francis, Roca Raton, 2006.

Materials and equipment required for complete CMP process integration is outlined in the book by J. M. Steigerwald, S. P. Murarka, and R. J. Gutmann in “Chemical Mechanical Planarization of Microelectronic Materials”, Chapter 1, John Wiley & Sons, New York, 1997. They include (i) consumables, (ii) distribution management systems, (iii) CMP polishers, (iv) post CMP clean systems, and (v) thin film measurements. The consumables used are (1) oxide slurries, (2) metal slurries, (3) post clean chemicals, (4) polishing pad, and (5) carrier films. Distribution management systems comprise of (1) mixing, (2) dirstribution, (3) dispersing, and (4) filtration. CMP polishers include (1) single head, (2) multi-head, (3) end-point detection. Post CMP clean systems consist of (1) scrubbers, (2) megasonic, and (3) other clean. Thin film measurements include (1) surface profiling, (2) non-uniformity, (3) surface defects, and (4) other inspecton.

The Dₛ particle size for purposes of this patent application and appended claims means that s percent by volume of the solid particles have a particle diameter no greater than the Dₛ value. For the purposes of this definition, the particle size distribution (PSD) used to define the Dₛ value is measured using commonly used techniques, for example, centrifugal separation disc, laser scattering techniques using a Horiba LA910, Microtrac Model S3500 particle size analyzer from Microtrac, Inc. (Clearwater, Fla.), or acoustic and electroacoustic method, for example, DT-1200 Acoustic and Electroacoustic Spectrometer from Dispersion Technology, Bedford Hills, N.Y., and ZetaPals from Brookhaven Instrument Corp., Holtsville, N.Y. The “median particle diameter” is the D₅₀ value for a specified plurality of metal oxide particles.

“Particle diameter” as used herein means the diameter of a specified spherical particle or the equivalent diameter of non-spherical particles as measured by laser scattering method using for example Microtrac Model S3500 particles size analyzer.

According to another aspect of the invention, a composition of polishing medium is provided. “Polishing medium” is defined herein as a combination of solid particles suspended in a liquid medium used in a polishing process where materials of a target surface are removed in a controllable manner to achieve ultimate evenness or surface perfection for a particular application.

In one embodiment of the invention, the polish medium may contain one or more milling aids to facilitate the polishing process. During the polishing process, polishing aids can be used to help dislodge finer particles removed from the target surface or to prevent the removed fine particles from reattaching to the target surface. The polishing medium can include a combination of solid particles and other milling aid additives.

In yet another embodiment, the milling aid includes but not limited to acids and bases to adjust medium pH, surface active reagents, electrolytes, soluble ionic polymers, and non-ionic polymers, suspension agent, wetting agent, water soluble polymers, electrolytes, and polyelectrolytes. “Milling aid” refers to a chemical or an additive its introduction into the polishing suspension or slurry can result in improved performance of suspension or slurry in terms of polishing efficiency, surface planarization, stability of the suspension or slurry, consistency of the suspension or slurry, and modification of surface characteristics such as surface charge or zeta potential. The milling aid is selected from the group of inorganic or organic acids(i.e., nitric acid, hydrochloric acid, acetic acid), bases (i.e., sodium hydroxide, sodium carbonate, potassium hydroxide), dispersants, surfactants, water soluble polymers, electrolytes and polyelectrolytes.

“Polishing rate” is defined herein as the amount of materials removed or dislodged during each contact between the targeted surface and the polishing medium or per unit time. For example, if 0.01 micron thick of material of the targeted surface is removed in a single round of contact, the polishing rate of this polishing slurry is 0.01 micron per pass. If the pad is rotating at 50 RPM, then the polishing rate is at 0.5 microns/min. Polishing rate is affected by size and shape of the polishing particles, hardness and chemical nature of the polishing particles, concentration of the polishing particles, presence of the polishing additives or aids, polishing pad, contact angle between the targeted surface and the polishing pad, rotation speed of the polishing pad, and the application rate of the polishing medium.

In one embodiment of the invention, the particle size of the polishing particles is at least 0.1 mm, more preferably is at least 0.12 mm, and even more preferably is at least 0.15 mm. Larger polishing particles tend to give high polishing rate but result in poor surface uniformity. Higher pad rotation speeds result in fast polishing. A higher polishing medium concentration and higher application rate produce a higher rate of polishing. Presence of certain polishing additives or aides could lead to faster dislodge of the removed materials from the targeted surface.

“Milling medium” refers to particles charged into a mill chamber to facilitate particle size reduction of the targeted particles during processing. Effective milling medium typically has the characteristics of (1) high density, (2) inert or having very low activity towards milling chamber or other vessel surfaces or the slurry to be processed, (3) high hardness, (4) spherical, and (5) high surface uniformity or smoothness. Zirconia, especially stabilized zirconia, is widely used as milling medium.

In one embodiment of the invention, the density of the milling medium is at least 2 g/ml, more preferably is at least 2.2 g/ml, and even more preferably is at least 2.5 g/ml.

In another embodiment of the invention, milling medium materials of high harness are preferred. “Hardness” unless otherwise stated, is referred to Mohs' scale that is used to characterize resistance to scratch of surface of a given materials by the ability of a harder materials to scratch a softer material. It was originally developed to compare hardness of naturally occurred minerals but is widely used in the field of materials science and engineering. The mineral with the least hardness is talc having a Mohs hardness of 1. Diamond has a Mohs hardness of 15, the highest number on the Mohs scale. This scale of 1 to 15 is also called modified Mohs scale of hardness.

In yet another embodiment of the invention, the milling medium is selected from a group of high purity and refractory ceramic microspheres.

### EXAMPLES

### Example—1

A slurry of alumina was prepared by mixing 600.00 grams of alumina and 400.00 grams of distilled water under constant mixing using a homogenizer at 500 RPM to give 1000.00 grams of slurry. This slurry has a solids content of 60% wt/wt. The alumina used was obtained from Jiyuan Chemicals, Jinan, Henan, China. The pH of the slurry measured at 8° C. was 10.7. Viscosity of this slurry was measured using a Brookfield DV-II viscometer, from Brookfield Engineering Laboratories Inc., Middleboro, Mass. Five different shear rates were used, 5, 10, 20, 30, 50 and 100 RPM. The results are given in FIG. 1. The slurry showed a strong shear thinning behavior.

### Example—2

An acid was used to adjust pH of the 60% alumina slurry from Example—1. Concentrated nitric acid (76%) was used to adjusting pH of the slurry. As acid was added, pH of the slurry was lowered. After the pH adjustment and mixing, viscosity of the newly obtained slurry was measured using the same viscometer as in Example-1 according to the same protocol. The results are given in Table 1. As pH was lowered, viscosity first increased but it then decreased after pH passed the neutral pH. Further lowering pH resulted in a dramatic reduction in slurry viscosity.

### Example—3

The slurry from Example-2 was milled for particle size reduction. The milling was carried out using an Eiger Mini 250 ML mill from Eiger Machinery, Grayslake, Ill. The mill was operated at 3600 RPM. The milling rate can be varied from low RPM to 5000 RPM. The temperature of the milled slurry was controlled by temperature and flow rate of the cooling water through the water jacket of the mill. The medium used is zirconia based mono-sized microspheres from Tosoh Corporation, Japan. The milling medium has a Mohs hardness of 8 or greater. Milling was carried out under circulation mode, in other words, the slurry coming out of the milling chamber was fed right back to the inlet port of the mill. One pass is defined as the milling time required for the entire slurry to go through the mill volume (including the inlet sample funnel but excluding milling medium and agitator) once. For example, if the mill volume is 600 ml, for 600 ml of slurry, at milling rate of 600 ml per minute, for one pass, it requires 1 minute. In other words, for 10 minutes continuous circulation, it has provided 10 passes of milling. Results of the slurry from Example-2 after pH adjustment to 4.5 using nitric acid are presented in Table 2. The sample was left at the ambient condition for 2 hrs, pH of the slurry changed from 4.5 to 5.0, but viscosity did not change significantly. After the milling started, viscosity of the slurry started to increase. As the milling continued, viscosity of the sullry increased dramatically and at the same time, pH of the slurry increased graudually.

### Example—4

The pH of the slurry from Example-3 was further adjusted from 6.1 to 4.3 after being milled seven passes at 3200 RPM. It was then milled using the same Eiger mill according to the same operation protocol. The resulting slurry was characterized for viscosity and pH. The results are given in Table 3. The pH of the slurry continued to increased as milling progressed. However, its pH did not increase beyond 5. Viscosity of the milled slurry remained very low, 242 cPs after 16 passes of milling.

### Example—5

Particle size analysis was conducted on the milled samples taken at different milling stages from Example-4. Particle size analysis was carried out after adjusting the pH of the diluted sample to pH=4. The dilution rate was 1 to 1,000. Measurements were performed using a centrifuge disc method. The results (particle size at the peak position) are given in Table 4. It is clear that a substantial reduction in particle size was achieved through the milling process.

Without wishing to bound by any given theory, to those skilled in the art, that a major reduction in slurry viscosity can result in major process advantages in terms of ease of operation, reduction in energy consumption, reduction or elimination of wearing and tearing of the milling equipment and milling medium, and elimination of problems associated with high viscosity, i.e., blocking, plugging of transfer lines. Also, it is highly appreciated by those skilled in the art of polishing slurry that a major reduction in particle size of the polishing slurry can result in better control of polishing performance, i.e., less imperfection, well controlled polishing rate, and superior surface smoothness or planarization. The present invention has demonstrated viscosity control through additives can lead to dramatic reduction in viscosity and effective particle size reduction.

TABLE 1
Viscosity of 60% Alumina after pH Adjustments

| pH | Acid Added | Slurry | Temperature | Viscosity (cPs) |
|---|---|---|---|---|
| Adjustment | (accumulated) (g) | pH | (° C.) | @ 10 RPM |
| No | 0 | 10.7 | 7 | 6,800 |
| Yes | 1.5 | 7.9 | 7 | 30,400 |
| Yes | 2.5 | 6.5 | 8 | 31,600 |
| Yes | 3.7 | 5.3 | 7 | 5,500 |
| Yes | 4.3 | 4.3 | 7 | 130 |

TABLE 2
Viscosity of Milled 60% Alumina after pH Adjustments

| Milled | | Temperature | | Viscosity (cPs) |
|---|---|---|---|---|
| (pass) | Comments | (° C.) | pH | @ 10 RPM |
| 0 | right after pH | 5 | 4.5 | 150 |
| | adjustment | | | |
| 0 | 2 hrs after pH | 4 | 5 | 180 |
| | adjustment | | | |
| 1 | milling | 8 | 5.2 | 1,880 |
| 2 | milling | 11 | 5.3 | 2,680 |
| 3 | milling | 11 | 5.5 | 5,550 |
| 4 | milling | 13 | 5.6 | 8,400 |
| 5 | milling | 14 | 5.8 | 9,600 |
| 6 | milling | 15 | 5.9 | 12,200 |
| 7 | milling | 14 | 6.1 | 16,200 |

TABLE 3
Slurry Properties of Milled 60% Alumina after Further pH Adjustment

| Milled | | Temperature | | Viscosity (cPs) |
|---|---|---|---|---|
| (pass) | Comments | (° C.) | pH | @ 10 RPM |
| 7 | adjust pH from | 11 | 4.3 | 120 |
| | 6.1 to 4.3 | | | |
| 8 | milling | 10 | 4.3 | 160 |
| 9 | milling | 12 | 4.4 | 140 |
| 10 | milling | 12 | 4.5 | 140 |
| 11 | milling | 12 | 4.6 | 148 |
| 12 | milling | 11 | 4.6 | 156 |
| 13 | milling | 11 | 4.7 | 156 |
| 14 | milling | 12 | 4.8 | 168 |
| 15 | milling | 12 | 4.9 | 208 |
| 16 | milling | 12 | 5.0 | 242 |

TABLE 4
Particle Size Results of Milled 60 wt. % Alumina
Slurry from Example 5

| Milling | Particle Size |
|---|---|
| (passes) | dₚₑₐₖ (νm) |
| 0 | 2.20 |
| 2 | 0.76 |
| 4 | 0.75 |
| 25 | 0.57 |

### DESCRIPTION OF FIGURE

FIG. 1 Viscosity of alumina slurry at 60 wt. % solids content: before milling, slurry pH is 10.7. Both pH and viscosity measurements were carried out at 7° C. It shows a strong shear-thinning behavior. From process operation point of view, a viscosity of 6,800 cPs at 10 RPM before milling, is regarded very high for normal operation. Therefore, ways to reduce slurry viscosity are highly sought after to improve process stability, reduce energy consumption, and reduce wearing and tiring on process equipments.

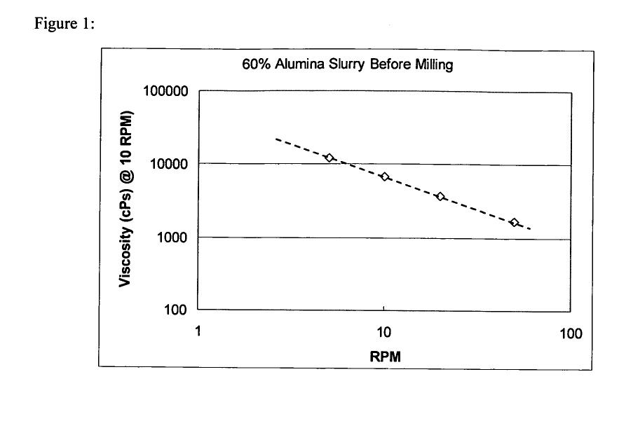

### REFERENCES CITED

1. J. M. Steigerwald, S. P. Murarka, and R. J. Gutmann, “Chemical Mechanical Planarization of Microelectronic Materials”, John Wiley & Sons, New York, pp. 7-12, p.30, 1997.
2. J-E. Otterstedt and D. A. Brandreth, “Small Particles Technology”, Plenum Press, N.Y., p.8, pp.18-19, 1998.
3. R. L. Xu, “Particle Characterization: Light Scattering Method”, Kluwer Academic Publisher, Dordrecht, The Netherlands, pp. 1-24, 2000.
4. P. A. Webb and C. Orr, “Analytical Methods in Fine Particle Technology”, Micromeritics Instrument Corp., Norcross, Ga., pp. 17-28, 1997.
5. A. M. Spasic and J-P. Hsu, “Finely Dispersed Particles: Micro-, Nano-, and Atto-Engineering”, Taylor & Francis, Roca Raton, pp. 329-40, 2006
6. M. J. Rosen, “Surfactants and Interfacial Phenomena”, Chapter 1, 3^{rd} Edition, John Wiley & Sons, Hoboken, N.J., pp. 1-33, 2004.

We claim:

1. A process for preparing a mixture of metal oxide particles comprising the steps of:
(a) forming a slurry containing a metal oxide, a slurrying agent and optionally a polishing aid;
(b) adjusting pH of the slurry to achieve desired rheological characteristics;
(c) milling the slurry to produce particle of desired particle size and size distribution, and;

2. The process of claim 1, wherein the metal oxide is at least 5 wt % of the slurry, but less than 95 wt %.

3. The process of claim 1, wherein the slurrying agent is water or an aqueous solution.

4. The process of claim 1, wherein upon pH adjustment, viscosity of the slurry is lowered by at least 5%, more preferably by at least 10%, even more preferably by at least 12%.

5. The process of claim 1, pH of the slurry is lowered by at least 0.05 unit, more preferably by at least 0.08 unit, even more preferably by at least 0.10 unit.

6. The process of claim 1, wherein the pH adjusting agent is an acid.

7. The process of claim 1, wherein the acid is selected from a group of inorganic acids used alone or in combination.

8. The process of claim 1, wherein the acid is selected from a group of water soluble organic acids used alone or in combination.

9. The process of claim 1, wherein a base can be used to assist pH adjustment.

10. The process of claim 1, wherein after milling particle size of the slurry is reduced by at least 5%, more preferably by at least 8%, even more preferably by at least 10%.

11. The process of claim 1, wherein after milling the average particle size of the milling particles is smaller than 10 microns, more preferably is smaller than 8 microns, even more preferably is smaller than 7 microns.

12. The process of claim 1, wherein the size of the milling medium is at least 0.1 mm, more preferably is at least 0.12 mm, and even more preferably is at least 0.15 mm.

13. The milling medium has a hardness on the Mohs scale greater than 6.

14. The process of claim 1, wherein the slurry produced has a viscosity of no more than 50,000 cPs at 10 RPM, more preferably of no more than 48,000 cPs at 10 RPM, even more preferably of no more than 46,000 cPs at 10 RPM all measured at ambient temperature.

15. A polishing medium comprising:
a plurality of metal oxide particles and a polishing aid.

16. A composition of claim 18, wherein the metal oxide is selected from the group consisting of alumina, silica, silica-alumina, titania, ceria, zeolite, molecular sieve, clay, zirconia, yttria, copper oxide, or metal doped forms thereof, and mixtures thereof.

17. A composition of claim 17, wherein the metal oxide has a surface area of no more than 350 m²/g, more preferably of no more than 250 m²/g, even more preferably of no more than 220 m²/g.

18. A composition of claim 17, wherein the polishing aid contains at least one ingredient that is an acid, base, surface active reagents, electrolytes, soluble ionic polymers, non-ionic polymers, wetting agent, water soluble polymers, electrolytes, and polyelectrolytes.

19. A composition of claim 17, wherein the amount of polishing aid is at least 20 ppm, more preferably at least 30 ppm, even more preferably at least 40 ppm.

20. A process for producing a polishing medium that can be used to achieve chemical and mechanical polishing of a solid surfaces resulting in:
(a) smoothness or planarization of a target surface;
(b) size reduction of target object;
(c) wherein the target is an article, a particle or a combination of thereof.

21. A process of claim 22, wherein the polishing rate is at most 1 microns per pass, more preferably at most 0.5 microns per pass, even more preferably at most 0.25 microns per pass.

22. A process for producing a slurry comprising of:
a plurality of metal oxide, clay, zeolite, molecular sieve, colloidal binder, or surface modifier:
(a) wherein the oxide is selected from the group of alumina, alumina-silica, calcium oxide, ceria, iron oxide, magnesia, manganese oxide, zirconia, yttria, copper oxide, mixed metal oxide, or combination of thereof;
(b) a milling medium is selected from the group of refractory materials including but not limited to alumina, silica, titania, ceria, zirconia, carbides, nitrides, mixed oxides or stabilized metal oxides.
